(19) United States
(12) Patent Application Publication
(10) Pub. No.: US 2020/0001867 A1
(43) Pub. Date: Jan. 2, 2020

(54) VEHICLE CONTROL APPARATUS, VEHICLE CONTROL METHOD, AND PROGRAM

(71) Applicant: HONDA MOTOR CO., LTD., Minato-ku, Tokyo (JP)

(72) Inventors: Akira Mizutani, Wako-shi (JP); Atsushi Ishioka, Wako-shi (JP)

(21) Appl. No.: 16/484,499

(22) PCT Filed: Mar. 1, 2017
(86) PCT No.: PCT/JP2017/008070

§ 371 Date: Aug. 8, 2019

(51) Int. Cl. B60W 30/095; B60W 10/04; G08G 1/16

(52) U.S. Cl. CPC B60W 30/095; B60W 10/04; B60W 2720/106; B60W 2550/306; G08G 1/166

(57) ABSTRACT

A vehicle control apparatus is a vehicle control apparatus includes a recognizer configured to recognize a vehicle A traveling in front of a host vehicle in a first lane in which the host vehicle travels, and a vehicle B traveling between the vehicle A and the host vehicle in a traveling direction in a second lane adjacent to the first lane, which are detected by a detector that detects a situation of a periphery of the host vehicle, an estimator configured to estimate a likelihood of changing lanes into the first lane by the vehicle B recognized by the recognizer, and a vehicle controller configured to control a speed of the host vehicle on the basis of a speed of the vehicle A and an estimation result of the estimator.

### TECHNICAL FIELD

The present invention relates to a vehicle control apparatus, a vehicle control method, and a program.

### BACKGROUND ART

In the related art, a technology for calculating a value of a probability of a nearby vehicle cutting in front of a host vehicle using a first distance between the host vehicle and a preceding vehicle traveling in the same lane as the host vehicle and traveling in front of the host vehicle, a second distance between the nearby vehicle traveling in a lane adjacent to a host lane and a vehicle traveling behind the nearby vehicle, and a relative speed between the host vehicle and the nearby vehicle is disclosed (see, for example, Patent Document 1).

### CITATION LIST

### Patent Literature

[Patent Document 1] Japanese Unexamined Patent Application, First Publication No. 2003-288691

### SUMMARY OF INVENTION

### Technical Problem

However, in the above technology, controlling a speed of a vehicle in consideration of a lane changing likelihood of the nearby vehicle may not be considered.

The present invention has been made in consideration of such circumstances, and an object of the present invention is to provide a vehicle control apparatus, a vehicle control method, and a program capable of performing speed control with less discomfort according to a lane changing behavior of a nearby vehicle.

### Solution to Problem

According to an aspect, a vehicle control apparatus includes a recognizer that recognizes a vehicle A traveling in front of a host vehicle in a first lane in which the host vehicle travels, and a vehicle B traveling between the vehicle A and the host vehicle in a traveling direction in a second lane adjacent to the first lane, the vehicle A and the vehicle B being detected by a detector that detects a situation of a periphery of the host vehicle; an estimator that estimates a likelihood of changing lanes into the first lane by the vehicle B recognized by the recognizer; and a vehicle controller that controls a speed of the host vehicle on the basis of a speed of the vehicle A and an estimation result of the estimator.

According to another aspect, the recognizer is configured to recognize a vehicle C traveling between the vehicle A and the host vehicle in a traveling direction in a third lane adjacent to the first lane and on a side opposite to the second lane, the vehicle C being detected by the detector that detects the situation of a periphery of the host vehicle, the estimator is configured to estimate a likelihood of changing lanes into the first lane by the vehicle C recognized by the recognizer, and the vehicle controller is configured to control a speed of the host vehicle on the basis of the speed of the vehicle A and a lane changing likelihood of a target vehicle having a high likelihood of changing lanes into the first lane in the estimation result of the estimator.

According to another aspect, the recognizer is configured to recognize a plurality of target vehicles including the vehicle B and the vehicle C, the target vehicles traveling between the vehicle A and the host vehicle in the traveling direction and traveling in the second lane or the third lane, the estimator is configured to estimate the likelihood of changing lanes into the first lane by each of the plurality of target vehicles recognized by the recognizer, and the vehicle controller is configured to control the speed of the host vehicle on the basis of the speed of the vehicle A and a lane changing likelihood of a target vehicle having a high likelihood of changing lanes into the first lane among the plurality of target vehicles in the estimation result of the estimator.

According to another aspect, the vehicle controller is configured to further control the speed of the host vehicle on the basis of the speed of a target vehicle having a high likelihood of changing lanes into the first lane among the plurality of target vehicles.

According to another aspect, the estimator is configured to control the speed of the host vehicle using a set speed instead of the speed of the vehicle A when the recognizer does not recognize the vehicle A within a set distance.

According to another aspect, the vehicle controller is configured to exclude, as the vehicle B or the vehicle C, a vehicle of which a rear end is not in front of a front end of the host vehicle in the traveling direction, or a vehicle of which the distance from a rear end thereof to the front end of the host vehicle is not equal to or greater than a predetermined distance.

According to another aspect, the vehicle controller is configured to exclude, as the vehicle B or the vehicle C, a vehicle of which the relative speed with respect to the host vehicle is negative.

According to another aspect, the vehicle controller is configured to exclude, as the vehicle B or the vehicle C, a vehicle of which the likelihood of changing lanes into the first lane in the estimation result of the estimator is equal to or smaller than a threshold value.

According to another aspect, the vehicle controller is configured to regard the vehicle B or the vehicle C of which the estimation result of the estimator is equal to or greater than a threshold value as the vehicle A in a process of repeatedly controlling the speed of the host vehicle.

According to another aspect, a vehicle control apparatus includes a recognizer configured to recognize a vehicle A traveling in front of a vehicle in a first lane in which the host vehicle travels, and a plurality of target vehicles traveling between the vehicle A and the host vehicle in the traveling direction and traveling in a lane adjacent to the first lane; an estimator configured to estimate a likelihood of changing lanes from the lane adjacent to the first lane to the first lane for each of the plurality of target vehicles recognized by the recognizer; and a vehicle controller configured to control a speed of the host vehicle on the basis of a speed of the vehicle A and a lane changing likelihood of a target vehicle having a high likelihood of changing lanes into the first lane among the plurality of target vehicles in an estimation result of the estimator.

According to another aspect, a vehicle control method includes recognizing, by a vehicle-mounted computer, a vehicle A traveling in front of a host vehicle in a first lane in which the host vehicle travels, and a vehicle B traveling between the vehicle A and the host vehicle in a traveling direction in a second lane adjacent to the first lane, the vehicle A and the vehicle B being detected by a detector that detects a situation of a periphery of the host vehicle; estimating, by the vehicle-mounted computer, the likelihood of changing lanes into the first lane by the recognized vehicle B; and controlling, by the vehicle-mounted computer, the speed of the host vehicle on the basis of the speed of the vehicle A and a result of the estimation.

According to another aspect, a program causes a vehicle-mounted computer to: recognize a vehicle A traveling in front of a host vehicle in a first lane in which the host vehicle travels, and a vehicle B traveling between the vehicle A and the host vehicle in a traveling direction in a second lane adjacent to the first lane, the vehicle A and vehicle B being detected by a detector that detects a situation of a periphery of the host vehicle; estimate a likelihood of changing lanes into the first lane by the recognized vehicle B; and control a speed of the host vehicle on the basis of a speed of the vehicle A and a result of the estimation.

### Advantageous Effects of Invention

According to another aspect, the vehicle control apparatus controls the speed of the host vehicle on the basis of the speed of the vehicle A or the vehicle B and the estimation result of the estimator. Thus, it is possible to perform speed control with less discomfort according to a lane changing behavior of the nearby vehicle.

According to another aspect, when the recognizer does not recognize the vehicle A within the set distance, the estimator controls the speed of the host vehicle using the set speed instead of the speed of the vehicle A. Thus, it is possible to realize the above control even when the vehicle A is not present.

According to another aspect, the vehicle controller excludes a vehicle of which a rear end is not in front of a front end of the host vehicle in the traveling direction or a vehicle of which a distance from a rear end of the vehicle to a front end of the host vehicle is not equal to or greater than the predetermined distance as the vehicle B or the vehicle C. Thus, it is possible to suppress a meaningless change in a behavior of the vehicle due to erroneous detection of sensors. Further, it is possible to reduce a processing load.

According to another aspect, it is possible to exclude a vehicle having a low lane changing likelihood from processing targets and to reduce a processing load.

According to another aspect, the vehicle controller is configured to regard the vehicle B or the vehicle C of which the estimation result of the estimator is equal to or greater than the threshold value as the vehicle A. Thus, it is possible to treat a vehicle to be substantially regarded as a preceding vehicle, as such.

### BRIEF DESCRIPTION OF DRAWINGS

FIG. 1 is a block diagram of a vehicle system including an automated driving controller.

FIG. 2 is a diagram showing a state in which a relative position and an attitude of a host vehicle with respect to a travel lane are recognized by a host vehicle position recognizer.

FIG. 3 is a diagram showing a state in which a target locus is generated on the basis of a recommended lane.

FIG. 4 is a diagram showing an example of a scene in which a first controller estimates a likelihood of changing lanes in front of a host vehicle by a third vehicle.

FIG. 5 is a flowchart showing a flow of a process that is executed by the first controller.

FIG. 6 shows an example of a first index value derivation table.

FIG. 7 shows an example of a second index value derivation map.

FIG. 8 shows an example of a lane change estimation map.

FIG. 9 is a flowchart showing a flow of a process that is executed by a first controller of a modification example.

FIG. 10 shows an example of a conditional second index value derivation map.

FIG. 11 is a diagram showing an example of a travel history of a third vehicle.

FIG. 12 is a diagram showing a functional configuration of an automated driving controller of a modification example 2;

FIG. 13 is a diagram showing an example of a scene in which a merged road is present.

FIG. 14 is a flowchart showing a flow of a process that is executed by the first controller.

FIG. 15 is a diagram showing speed control.

FIG. 16 is a flowchart showing a flow of a process of speed control that is executed by the first controller.

### DESCRIPTION OF EMBODIMENTS

Hereinafter, embodiments of a vehicle control apparatus, a vehicle control method, and a program according to the present invention will be described with reference to the drawings. Although a case in which the vehicle control apparatus is applied to an automated driving vehicle will be described below, the present invention is not limited thereto and the vehicle control apparatus may also be applied to a vehicle that follows a preceding vehicle traveling in front of a host vehicle. In this case, the host vehicle controls a vehicle on the basis of a speed determined by the vehicle control apparatus.

### [Entire Configuration]

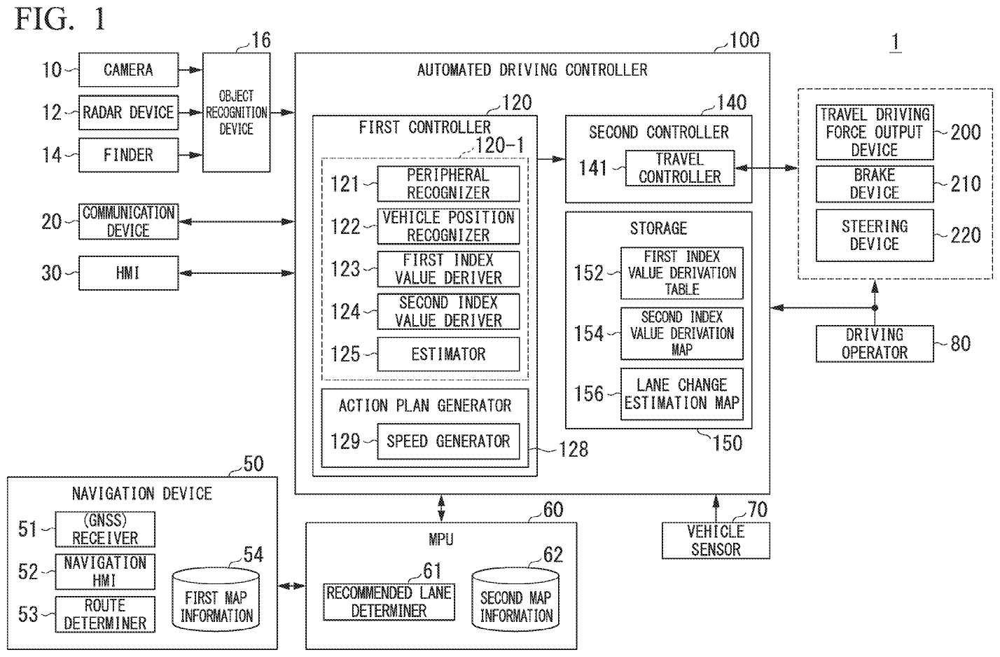

FIG. 1 is a configuration diagram of a vehicle system 1 including an automated driving controller 100. A vehicle in which the vehicle system 1 is mounted is, for example, a vehicle such as a two-wheeled, three-wheeled, or four-wheeled vehicle. A driving source thereof is an internal combustion engine such as a diesel engine or a gasoline engine, an electric motor, or a combination thereof. The electric motor is operated using power generated by a generator connected to the internal combustion engine, or discharge power of a secondary battery or a fuel cell.

The vehicle system 1 includes, for example, a camera 10, a radar device 12, a finder 14, an object recognition device 16, a communication device 20, a human machine interface (HMI) 30, a navigation device 50, a micro-processing unit (MPU) 60, a vehicle sensor 70, a driving operator 80, an automated driving controller 100, a travel driving force output device 200, a brake device 210, and a steering device 220. These devices or equipment are connected to each other by a multiplex communication line such as a controller area network (CAN) communication line, a serial communication line, a wireless communication network, or the like. It should be noted that the configuration shown in FIG. 1 is merely an example, and a part of the configuration may be omitted, or another configuration may be added.

The camera 10 is, for example, a digital camera using a solid-state imaging element such as a charge coupled device (CCD) or a complementary metal oxide semiconductor (CMOS). One or a plurality of cameras 10 are attached to any places on a vehicle in which the vehicle system 1 is mounted (hereinafter referred to as a host vehicle M). In the case of forward imaging, the camera 10 is attached to an upper portion of a front windshield, a rear surface of a rearview mirror, or the like. The camera 10, for example, periodically repeatedly images the surroundings of the host vehicle M. The camera 10 may be a stereo camera.

The radar device 12 radiates radio waves such as millimeter waves to the surroundings of the host vehicle M and detects radio waves (reflected waves) reflected by an object to detect at least a position (distance and orientation) of the object. One or a plurality of radar devices 12 are attached to any places on the host vehicle M. The radar device 12 may detect a position and a speed of an object using a frequency modulated continuous wave (FM-CW) scheme.

The finder 14 is a light detection and ranging, or laser imaging detection and ranging (LIDAR) that measures scattered light with respect to irradiation light and detects a distance to a target. One or more finders 14 are attached at any places on the vehicle M.

The object recognition device 16 performs a sensor fusion process on detection results of some or all of the camera 10, the radar device 12, and the finder 14 to recognize a position, type, speed, and the like of an object. The object recognition device 16 outputs recognition results to the automated driving controller 100.

The communication device 20, for example, communicates with another vehicle near the host vehicle M using a cellular network, a Wi-Fi network, Bluetooth (registered trademark), dedicated short range communication (DSRC), or the like or communicates with various server devices via a wireless base station.

The HMI 30 presents various types of information to an occupant of the host vehicle M and receives an input operation from the occupant. The HMI 30 includes various display devices, speakers, buzzers, a touch panel, switches, keys, and the like.

The navigation device 50 includes, for example, a global navigation satellite system (GNSS) receiver 51, a navigation HMI 52, and a route determiner 53, and holds first map information 54 in a storage device such as a hard disk drive (HDD) or a flash memory. The GNSS receiver specifies a position of the host vehicle M on the basis of a signal received from a GNSS satellite. The position of the host vehicle M may be specified or supplemented by an inertial navigation system (INS) using an output of the vehicle sensor 70. The navigation HMI 52 includes a display device, a speaker, a touch panel, keys, and the like. The navigation HMI 52 may be partly or wholly shared with the above-described HMI 30. The route determiner 53, for example, determines a route from the position of the host vehicle M (or any input position) specified by the GNSS receiver 51 to a destination input by the occupant using the navigation HMI 52 by referring to the first map information 54. The first map information 54 is, for example, information in which a road shape is represented by links indicating roads and nodes connected by the links. The first map information 54 may include a curvature of the road, point of interest (POI) information, and the like. The route determined by the route determiner 53 is output to the MPU 60. Further, the navigation device 50 may perform route guidance using the navigation HMI 52 on the basis of the route determined by the route determiner 53. It should be noted that the navigation device 50 may be realized, for example, by a function of a terminal device such as a smartphone or a tablet terminal possessed by a user. Further, the navigation device 50 may transmit a current position and a destination to a navigation server via the communication device 20 and acquire the route with which the navigation server replies.

The MPU 60, for example, functions as a recommended lane determiner 61, and holds second map information 62 in a storage device such as an HDD or a flash memory. The recommended lane determiner 61 divides the route provided from the navigation device 50 into a plurality of blocks (for example, divides the route every 100 [m] in a vehicle traveling direction), and determines a target lane for each block by referring to the second map information 62. The recommended lane determiner 61 determines in which lane from the left the host vehicle M travels. The recommended lane determiner 61 determines the recommended lane so that the host vehicle M can travel along a reasonable route for progression to a branch destination when there is a branch point, a merging point, or the like on the route.

The second map information 62 is map information with higher accuracy than the first map information 54. The second map information 62 includes, for example, information on a center of the lane or information on a boundary of the lane. Further, the second map information 62 may include road information, traffic regulation information, address information (address and postal code), facility information, telephone number information, and the like. The road information includes information indicating types of roads such as expressways, toll roads, national highways, and prefectural roads, or information such as the number of lanes on a road, a width of each lane, a gradient of the road, a position of the road (three-dimensional coordinates including a longitude, a latitude, and a height), a curvature of a curve of the lane, a position of a merging or branching point of a lane, and signs provided on a road. The second map information 62 may be updated at any time through access to another device using the communication device 20.

Further, information indicating a gate structure of an entrance toll gate or an exit toll gate is stored in the second map information 62. The information indicating the gate structure is, for example, the number of gates provided at the toll gate, information indicating positions of gates, and information indicating types of gates (information on an ETC dedicated gate, a general gate, or the like).

The vehicle sensor 70 includes, for example, a vehicle speed sensor that detects a speed of the host vehicle M, an acceleration sensor that detects acceleration, a yaw rate sensor that detects an angular speed around a vertical axis, and an orientation sensor that detects a direction of the host vehicle M.

The driving operator 80 includes, for example, an accelerator pedal, a brake pedal, a shift lever, a steering wheel, and other operators. A sensor that detects the amount of operation or the presence or absence of operation is attached to the driving operator 80, and a result of the detection is output to one or both of the automated driving controller 100 or the travel driving force output device 200, the brake device 210 and the steering device 220.

The automated driving controller 100 includes, for example, a first controller 120, a second controller 140, and a storage 150. Each of the first controller 120 and the second controller 140 is realized, for example, by a processor such as a central processing unit (CPU) executing a program (software). Some or all of respective functional units may be realized by hardware such as a large scale integration (LSI), an application specific integrated circuit (ASIC), or a field-programmable gate array (FPGA) or may be realized by software and hardware in cooperation. The storage 150 is realized by an HDD or a flash memory. A first index value derivation table 152, a second index value derivation map 154, and a lane change estimation map 156, which will be described below, are stored in the storage 150.

The first controller 120 includes, for example, a peripheral recognizer 121, a host vehicle position recognizer 122, a first index value deriver 123, a second index value deriver 124, an estimator 125, and an action plan generator 128. A combination of the peripheral recognizer 121, the host vehicle position recognizer 122, the first index value deriver 123, the second index value deriver 124, and the estimator 125 is an example of a “lane change estimation device (120-1 in FIG. 1).” A combination of the peripheral recognizer 121 and the host vehicle position recognizer 122 is an example of a “detector.” A combination of the action plan generator 128 and the second controller 140 is an example of a “vehicle controller.”

The peripheral recognizer 121 recognizes a state such as a position, a speed, and an acceleration of a nearby vehicle on the basis of information input from the camera 10, the radar device 12, and the finder 14 via the object recognition device 16. The position of the nearby vehicle may be represented by a representative point such as a centroid or a corner of the nearby vehicle or may be represented by an area represented by a contour of the nearby vehicle. The “state” of the nearby vehicle may include an acceleration or jerk of the nearby vehicle, or an “action state” (for example, whether the nearby vehicle is changing lanes or is about to change a lane). Further, the peripheral recognizer 121 may also recognize a position of a guardrail, a utility pole, a parked vehicle, a pedestrian, and other objects, in addition to the nearby vehicle.

The host vehicle position recognizer 122 recognizes, for example, a lane in which the host vehicle M is traveling (a travel lane) and a relative position and posture of the host vehicle M with respect to the travel lane. The host vehicle position recognizer 122, for example, compares a pattern of a road marking line (for example, an arrangement of a solid line and a broken line) obtained from the second map information 62 with a pattern of a road marking line near the host vehicle M recognized from an image captured by the camera 10 to recognize the travel lane. In this recognition, the position of the host vehicle M acquired from the navigation device 50 or a processing result of the INS may be additionally considered.

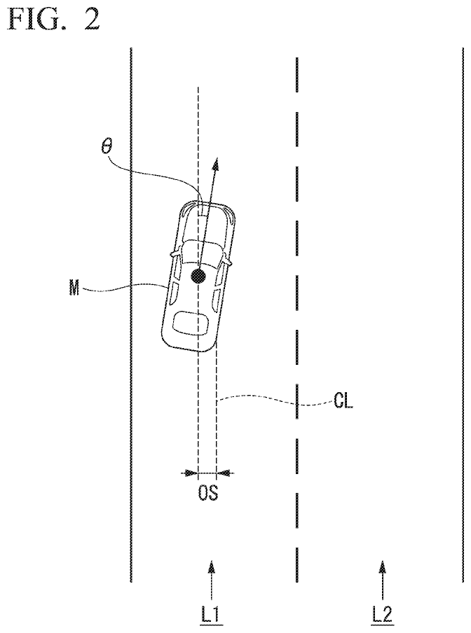

The host vehicle position recognizer 122 recognizes, for example, a position or a posture of the host vehicle M with respect to the travel lane. FIG. 2 is a diagram showing a state in which a relative position and posture of the host vehicle M with respect to a travel lane L1 are recognized by the host vehicle position recognizer 122. The host vehicle position recognizer 122, for example, recognizes a deviation OS of a reference point (for example, a centroid) of the host vehicle M from a travel lane center CL and an angle θ of a traveling direction of the host vehicle M with respect to a line connecting the travel lane center CL as the relative position and posture of the host vehicle M with respect to the travel lane L1. It should be noted that, alternatively, the host vehicle position recognizer 122 may recognize, for example, a position of the reference point of the host vehicle M with respect to any one of side end portions of the host travel lane L1 as a relative position of the host vehicle M with respect to the travel lane. The relative position of the host vehicle M recognized by the host vehicle position recognizer 122 is provided to the recommended lane determiner 61 and the action plan generator 128.

Details of the first index value deriver 123, the second index value deriver 124, and the estimator 125 will be described below.

The action plan generator 128 determines events to be sequentially executed in the automated driving so that the host vehicle M travels along the recommended lane determined by the recommended lane determiner 61 and so that the host vehicle M can cope with surrounding situations of the host vehicle M. The events include, for example, a constant-speed traveling event in which a vehicle travels on the same travel lane at a constant speed, a following traveling event in which a vehicle follows a preceding vehicle, a lane changing event, a merging event, a branching event, an emergency stopping event, a handover event in which automated driving is ended and switching to manual driving is performed, and a toll gate event (to be described below) that is executed when a vehicle passes through a toll gate, and the like. Further, an action for avoidance may be planned on the basis of the surrounding situation of the host vehicle M (presence of nearby vehicles or pedestrians, lane narrowing due to road construction, or the like) during execution of these events.

The action plan generator 128 generates a target locus in which the host vehicle M will travel in the future. The target locus includes, for example, a speed element. For example, a plurality of future reference times may be set for each predetermined sampling time (for example, every several tenths of a [sec]), and the target locus may be generated as a set of target points (locus points) that a vehicle is to reach at respective reference times. Therefore, when an interval between the locus points is great, this indicates that the vehicle travels at a high speed in a section between the locus points.

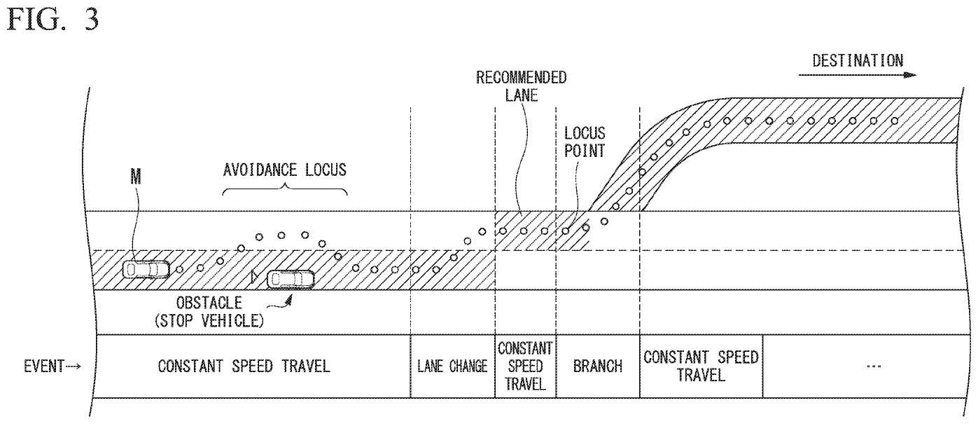

FIG. 3 is a diagram showing a state in which the target locus is generated on the basis of the recommended lane. As shown in FIG. 3, the recommended lane is set so that a vehicle conveniently travels along a route to a destination. The action plan generator 128 activates the lane change event, the branching event, the merging event, or the like when a vehicle comes within a predetermined distance (which may be determined according to a type of event) in front of a point at which the recommended lane is switched. When it is necessary to avoid an obstacle during the execution of each event, an avoidance locus is generated as shown in FIG. 3.

The action plan generator 128 generates, for example, a plurality of target locus candidates, and selects an optimal target locus at that time on the basis of the viewpoint of safety and efficiency.

Further, the action plan generator 128 includes a speed generator 129. Details of the speed generator 129 will be described below.

The second controller 140 includes a travel controller 141. The travel controller 141 controls the travel driving force output device 200, the brake device 210, and the steering device 220 so that the host vehicle M passes through the target locus generated by the action plan generator 128 according to a scheduled time.

The travel driving force output device 200 outputs a travel driving force (torque) for traveling of the vehicle to the driving wheels. The travel driving force output device 200 includes, for example, a combination among an internal combustion engine, an electric motor, a transmission, and the like, and an ECU that controls these. The ECU controls the above configuration according to information input from the travel controller 141 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the travel controller 141 or information input from the driving operator 80 so that a brake torque according to a braking operation is output to each wheel. The brake device 210 may include a mechanism that transfers the hydraulic pressure generated by the operation of the brake pedal included in the driving operator 80 to the cylinder via a master cylinder as a backup. It should be noted that the brake device 210 is not limited to the configuration described above and may be an electronically controlled hydraulic brake device that controls the actuator according to information input from the travel controller 141 and transfers the hydraulic pressure of the master cylinder to the cylinder.

The steering device 220 includes, for example, a steering ECU and an electric motor. The electric motor, for example, changes a direction of the steerable wheels by causing a force to act on a rack and pinion mechanism. The steering ECU drives the electric motor according to information input from the travel controller 141 or information input from the driving operator 80 to change the direction of the steerable wheels.

[Process of Estimating Lane Changing Likelihood]

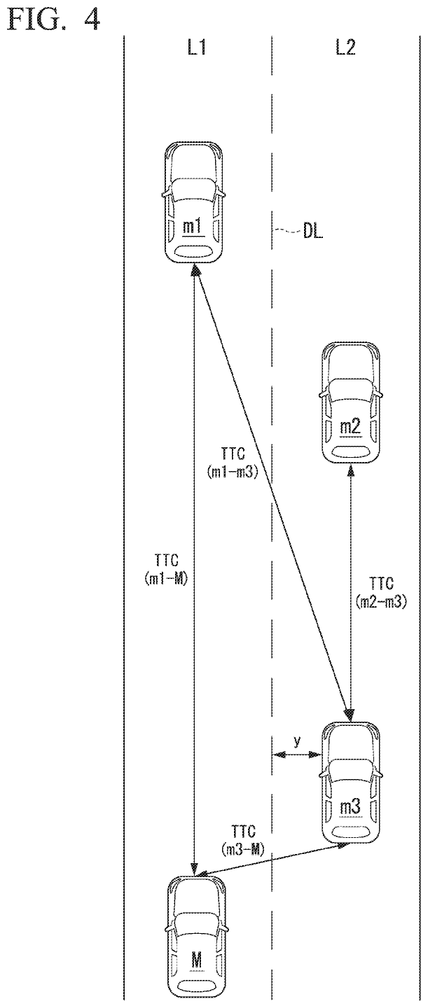

FIG. 4 is a diagram showing an example of a scene in which the first controller 120 estimates the likelihood of the third vehicle changing lanes in front of the host vehicle M. The first index value deriver 123 derives a first index value based on a relationship regarding a traveling direction between two vehicles among the host vehicle M, a first vehicle m1 traveling in front of the host vehicle M in the first lane (travel lane) L1 in which the host vehicle M travels, a second vehicle m2 traveling in a second lane L2 adjacent to the first lane L1 and traveling in front of the host vehicle M, and a third vehicle m3 traveling in the second lane L2 and traveling behind the second vehicle m2, for a plurality of sets of two vehicles, on the basis of recognition results of the peripheral recognizer 121 and the host vehicle position recognizer 122.

The first index value includes at least one of a time until the two vehicles come within a predetermined distance of each other, a distance between the two vehicles, a time-headway in the two vehicles, and a relative speed of the two vehicles. The time-headway is a time that is arbitrarily set in advance (for example, 1.5 seconds or 2 seconds), and is a time in which a following vehicle can maintain a state in which safety can be secured without interfering with a preceding vehicle when the preceding vehicle suddenly decelerates or when the preceding vehicle suddenly stops.

The second index value deriver 124 derives the second index value regarding the third vehicle m3 on the basis of the position in a lateral direction of the third vehicle m3 and at least one of the amount of movement in a lateral direction of the third vehicle m3 and a movement speed in the lateral direction of the third vehicle m3 in a predetermined period.

The estimator 125 estimates the likelihood of the third vehicle changing lanes on the basis of the index value (first index value) derived by the first index value deriver 123 and a position in a lateral direction of the third vehicle. Further, the estimator 125 estimates the lane changing likelihood of the third vehicle m3 on the basis of the first index value derived by the first index value deriver 123 and the second index value derived by the second index value deriver 124.

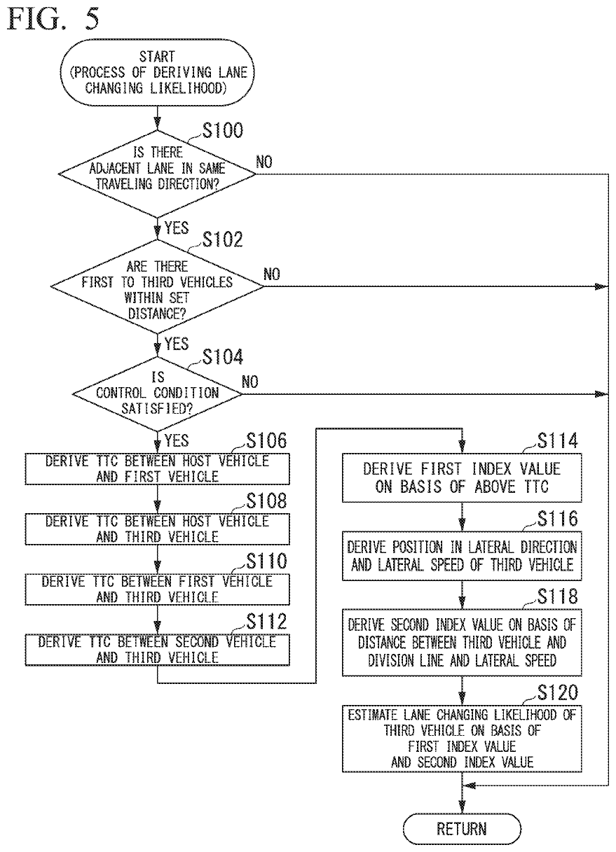

FIG. 5 is a flowchart showing a flow of a process that is executed by the first controller 120. This process is performed at predetermined periods. Hereinafter, each process will be described with reference to FIG. 4 described above.

First, the first controller 120 determines whether or not there is the second lane L2 in the same traveling direction as the traveling direction of the first lane L1 in which the host vehicle M travels, on the basis of the current position of the host vehicle M and the information acquired from the second map information 62 (step S100). When there is no second lane L2 in the same traveling direction, a process of one routine of this flowchart ends.

When there is the second lane L2 in the same traveling direction, the first controller 120 determines whether or not the first to third vehicles m1 to m3 are present within a set distance from the host vehicle M, on the basis of the recognition results of the peripheral recognizer 121 and the host vehicle position recognizer 122 (step S102). For example, the set distance is set for each of the first to third vehicles m1 to m3. The first index value deriver 123 determines, for example, whether or not each of the first to third vehicles m1 to m3 is present within the set distance set for the target vehicle. In the example of FIG. 4, it is assumed that the first to third vehicles m1 to m3 are present within set distances set for the respective vehicles.

It should be noted that the first controller 130 also determines that there is the third vehicle m3 within the set distance even when there is the third vehicle m3 behind or in the lateral direction of the host vehicle M. When the first to third vehicles m1 to m3 are not present within a predetermined distance from the host vehicle M, the process of one routine of this flowchart ends.

When the first to third vehicles m1 to m3 are present within the predetermined distance from the host vehicle M, the estimator 125 determines whether or not a predetermined control condition is satisfied (step S104). The predetermined control condition is, for example, that an inter-vehicle distance between the first vehicle m1 and the host vehicle M is equal to or greater than a threshold value. Further, the predetermined control condition may be, for example, that a relative speed of the third vehicle m3 with respect to the host vehicle M is positive when a distance between the host vehicle M and the third vehicle m3 in the traveling direction is smaller than a first distance (when the inter-vehicle distance is short).

Further, the predetermined control condition may be, for example, that the relative speed of the third vehicle m3 with respect to the host vehicle M is positive and the relative speed is equal to or greater than a predetermined speed when the distance between the host vehicle M and the third vehicle m3 in the traveling direction is equal to or greater than the first distance and smaller than a second distance (when the inter-vehicle distance is intermediate). When the distance between the host vehicle M and the third vehicle m3 in the traveling direction is equal to or greater than the second distance (when the inter-vehicle distance is sufficiently long), the estimator 125 may determine that the predetermined control condition is satisfied since there is a sufficient area between the host vehicle M and the third vehicle m3 even in a case in which the relative speed of the third vehicle m3 with respect to the host vehicle M is not positive. When the predetermined control condition is not satisfied, the process of this flowchart ends.

When the predetermined control condition is satisfied, the first index value deriver 123 derives TTC(m1-M) between the host vehicle M and the first vehicle m1 (step S106). TTC (Time To Collision) is a value obtained by dividing the inter-vehicle distance between a preceding vehicle (a rear end thereof) and a subsequent vehicle (a front end thereof) in the traveling direction by a relative speed.

Then, the first index value deriver 123 derives TTC(M-m3) between the host vehicle M and the third vehicle m3 (step S108), derives TTC(m1-m3)) between the first vehicle m1 and the third vehicle m3 (step S110), and derives TTC(m2-m3) between the second vehicle m2 and the third vehicle m3 (step S112).

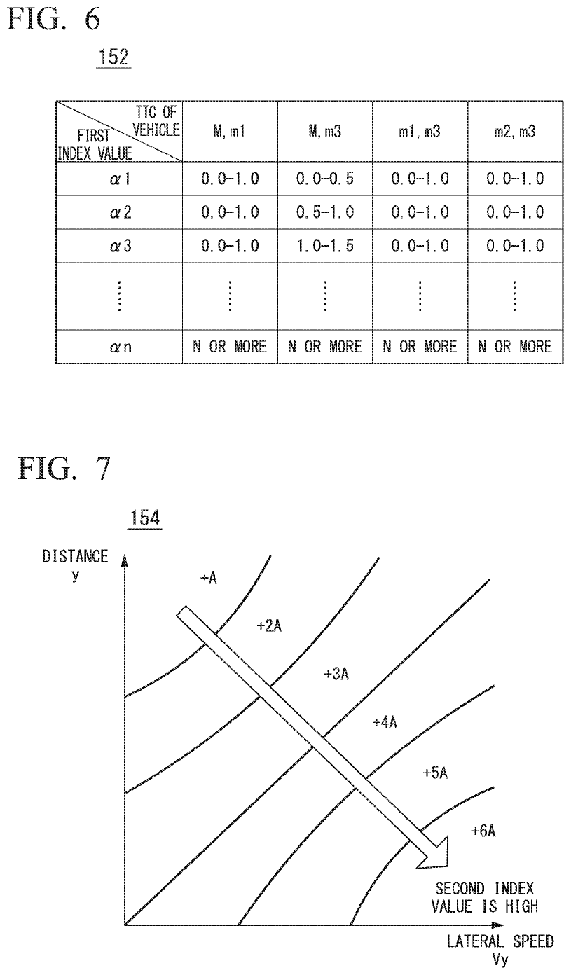

Then, the first index value deriver 123 derives the first index value on the basis of the TTCs derived through the processes of steps S106 to S112 above and the first index value derivation table 152 (step S114). FIG. 6 shows an example of the first index value derivation table 152. TTCs in a plurality of sets of two vehicles are stored in association with the first index values α1 to αn in the first index value derivation table 152. For example, the first index value is great in an order of α1 to α3.

When the TTC between the host vehicle M and the first vehicle m1 is long, the first index value tends to be larger than that when the TTC is short. When the TTC between the first vehicle m1 and the third vehicle m3 is long, the first index value tends to be larger than that when the TTC is short. When the TTC between the second vehicle m2 and the third vehicle m3 is short, the first index value tends to be larger than that when the TTC is long. When the TTC between the host vehicle M and the first vehicle m1 is longer than the TTC between the second vehicle m2 and the third vehicle m3, the first index value tends to be larger than that when the TTC between the host vehicle M and the first vehicle m1 is shorter than the TTC between the second vehicle m2 and the third vehicle m3.

The first index value derivation table 152 is generated on the basis of a correlation between the first index value derived from a result of observation of the third vehicle m3 that actually changes lanes, an experimental scheme, simulation, or the like in advance, and the TTC in two vehicles. The two vehicles are, for example, the host vehicle M and the first vehicle m1, the host vehicle M and the third vehicle m3, the first vehicle m1 and the third vehicle m3, and the second vehicle m2 and the third vehicle m3, other than the first vehicle m1 and the second vehicle m2. A map or function may be used instead of (in addition to) the first index value derivation table 152 for derivation of the first index value.

Then, the first index value deriver 123 derives a position in a lateral direction and a lateral speed Vy of the third vehicle m3 on the basis of the recognition result of the peripheral recognizer 121 (step S116). The position of the third vehicle m3 in the lateral direction is the position of the third vehicle m3 with respect to the first lane L1 in which the host vehicle M travels, and is a distance y between a division line DL that divides the first lane L1 and the second lane L2 and the third vehicle m3. The distance y is, for example, the shortest distance between the side of the third vehicle m3 and the division line DL.

Then, the estimator 125 derives the second index value on the basis of the distance y between the third vehicle m and the division line DL and the lateral speed Vy of the third vehicle m3 by referring to the second index value derivation map 154 (step S118). FIG. 7 shows an example of the second index value derivation map 154. In the second index value derivation map 154, the distance y and the lateral speed Vy of the third vehicle m3 (a direction approaching the division line DL is positive) are stored in association with the second index value. It should be noted that in FIG. 7, “A” is a set value. The second index value tends to be greater when the distance y is shorter. Further, the second index value tends to be greater when the lateral speed Vy is higher. The second index value derivation map 154 is generated on the basis of a correlation among the second index value derived from the result of observation of the third vehicle m3 that actually changes lanes, the experimental scheme, the simulation, or the like in advance, the distance y, and the lateral speed Vy of the third vehicle m3.

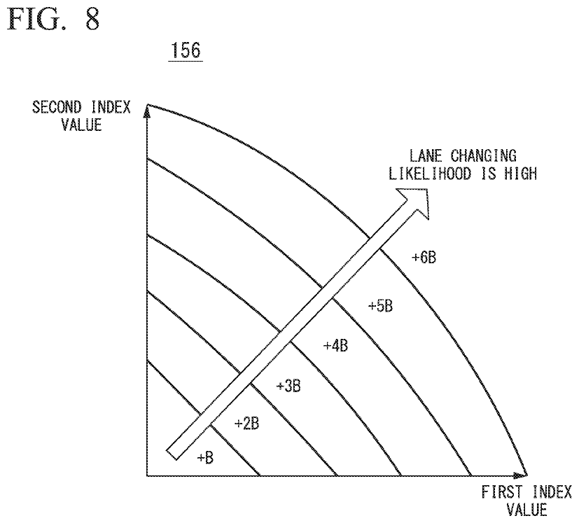

Then, the estimator 125 estimates the likelihood of the third vehicle m performing lane changing into the first lane L1 on the basis of the first index value and the second index value by referring to the lane change estimation map 156 (see step S120). FIG. 8 is a diagram showing an example of the lane change estimation map 156. In the lane change estimation map 156, the first index value and the second index value are stored in association with an estimated index value indicating the lane changing likelihood of the third vehicle m3. It should be noted that in FIG. 8, “B” is a set value. The estimated index value tends to increase when the first index value or the second index value increases. The lane change estimation map 156 is generated on the basis of a correlation between the first index value and the second index value derived from the result of observation of the third vehicle m3 that actually changes lanes, the experimental scheme, the simulation, or the like in advance. Accordingly, the process of one routine of this flowchart ends.

It should be noted that a case in which the distance y and the lateral speed Vy of the third vehicle m3 may be used for derivation of the second index value has been described in the above-described example, only the distance y or the distance y and any parameter may be used for the derivation of the second index value. For example, the amount of movement in a lateral direction of the third vehicle m3 in a predetermined time may be used, in addition to the position of the third vehicle in the lateral direction and the lateral speed Vy of the third vehicle m3, for derivation of the second index value. For example, the second index value deriver 124 derives the greater second index value as the amount of movement in the lateral direction is larger.

Further, when a movement direction of the third vehicle m3 in the lateral direction is a direction directed to the first lane, the second index value deriver 124 derives the second index value that tends to be greater than that when the movement direction of the third vehicle m3 in the lateral direction is not the direction directed to the first lane. Accordingly, when the movement direction of the third vehicle m3 in the lateral direction is the direction directed to the first lane, the estimator 125 estimates that the lane changing likelihood of the third vehicle m3 is higher than that in a case in which the movement direction of the third vehicle m3 in the lateral direction is not the direction directed to the first lane.

Further, although a case in which TTC may be used for derivation of the first index value has been described in the above-described example, at least one of a distance between two vehicles, a time-headway in the two vehicles, and a relative speed of the two vehicles may be used instead of (in addition to) TTC for derivation of the first index value.

For example, when the distance between the two vehicles is used for derivation of the first index value, the first index value tends to increase when a distance between the host vehicle M and the first vehicle m1 is longer, a distance between the first vehicle m1 and the third vehicle m3 is longer, or a distance between the second vehicle m2 and the third vehicle m3 is shorter.

Further, for example, when the relative speed between the two vehicles may be used for derivation of the first index value, the first index value tends to be greater when the relative speed between the host vehicle M and the first vehicle m1 is lower or the speed of the first vehicle m1 is higher than the speed of the host vehicle M. Further, the first index value tends to be greater when the relative speed between the first vehicle m1 and the third vehicle m3 is lower or the speed of the first vehicle m1 is higher than the speed of the third vehicle m3. Further, the first index value tends to be greater when the relative speed between the second vehicle m2 and the third vehicle m3 is lower or the speed of the third vehicle m3 is higher than the speed of the second vehicle m2.

Further, when the time-headway of the two vehicles is used for derivation of the first index value, the first index value tends to be the same as that when TTC is used for derivation of the first index value.

Further, although in the above-described example, the first index value deriver 123 derives the first index value on the basis of the first index value based on the relationship regarding the traveling direction between the two vehicles except for the relationship regarding the traveling direction between the first vehicle m1 and the second vehicle m2, the first index value deriver 123 may derive the first index value using the relationship regarding the traveling direction between the first vehicle m1 and the second vehicle m2. In this case, when the first vehicle m1 is present in front of the second vehicle m2, the first index value is derived to tend to be greater than that in a case in which the first vehicle m1 is not present. Further, when the TTC (time-headway) between the first vehicle m1 and the second vehicle m2 is large, the first index value tends to be larger than that in a case in which the TTC is small. Further, when the relative speed of the second vehicle m2 with respect to the first vehicle m1 is positive, the first index value is derived to tend to be greater and the lane changing likelihood of the third vehicle m3 is estimated to be higher than that in a case in which the relative speed is negative. Further, when the relative speed of the second vehicle m2 with respect to the first vehicle m1 is positive, the first index value is derived to tend to be greater as when the relative speed is higher. Thus, the lane changing likelihood of the third vehicle m3 is estimated to be high.

Further, when an obstacle (for example, a stopped vehicle or a falling object) is present in front of the third vehicle m3, the estimator 125 may estimate that the likelihood of changing lanes from the second lane L2 to the first lane L1 in the third vehicle m3 is higher than that in a case in which the obstacle is not present. Further, when the lane disappears in front of the third vehicle m3, the estimator 125 may estimate that the likelihood of changing lanes from the second lane L2 to the first lane L1 in the third vehicle m3 is higher than that in a case in which the lane does not disappear.

Further, even when the first vehicle m1 or the second vehicle m2 is not present, the above process may be performed. In this case, the process of step S102 in FIG. 5 may be omitted, or in the process of step S102, the first controller 120 may determine whether or not any vehicle is present. Further, when the first vehicle m1 or the second vehicle m2 is not present, the first index value derivation table 152 corresponding to the case in which the first vehicle m1 or the second vehicle m2 is not present may be used, and TTC between a vehicle that is not present and another vehicle, a time-headway, and a distance between two vehicles may be regarded as a sufficiently great value or infinity. Further, when the first vehicle m1 or the second vehicle m2 is not present, the relative speed may be regarded as zero, or the set value when the first vehicle m1 or the second vehicle m2 is not present may be used.

Further, although the second index value is derived after the first index value is derived in the above-described example, the first index value may be derived after the second index value is derived. Further, in this case, when the second index value is equal to or smaller than the first threshold value, the likelihood of changing lanes into the first lane L1 in the third vehicle m3 may be estimated to be equal to or lower than a predetermined value. Further, when the distance y between the third vehicle m and the division line DL is equal to or smaller than a second threshold value or the relative speed between the host vehicle M and the third vehicle m3 is equal to or lower than a third threshold value (when the speed of the host vehicle M is higher than the speed of the third vehicle m3), the likelihood of changing lanes into the first lane L1 in the third vehicle m3 may be estimated to be equal to or lower than the predetermined value.

As described above, the estimator 125 may estimate the lane changing likelihood of the third vehicle m3 on the basis of the first index value derived by the first index value deriver 123 and the position of the third vehicle m3 in the lateral direction. Thus, it is possible to estimate the lane change of the third vehicle m3 more accurately.

It should be noted that a case in which the lane change estimation device 120-1 including the first index value deriver 123, the second index value deriver 124, and the estimator 125 is applied to an automated driving vehicle has been described in the above description, but the present invention is not limited thereto and when there is a vehicle estimated to have a high likelihood of changing lanes into the lane in which the host vehicle travels, the lane change estimation device 120-1 may be applied to a notification device that notifies an occupant of the vehicle that there is the vehicle estimated to have a high lane changing likelihood. Further, the lane change estimation device 120-1 may be applied not only to an automated driving vehicle but also to a vehicle that follows a preceding vehicle traveling in front of the host vehicle. In this case, when the lane change estimation device 121-1 notifies the host vehicle that there is a vehicle having a high likelihood of changing lanes from a lane adjacent to the lane in which the host vehicle travels to the lane in which the host vehicle travels, the host vehicle travels with a longer inter-vehicle distance between the preceding vehicle followed by the host vehicle and the host vehicle.

### Modification Example 1

In modification example 1, switching from the second index value derivation map 154 to be used when the second index value is derived to a conditional second index value derivation map 155 may be performed according to a lighting state of a direction indicator of the third vehicle m3.

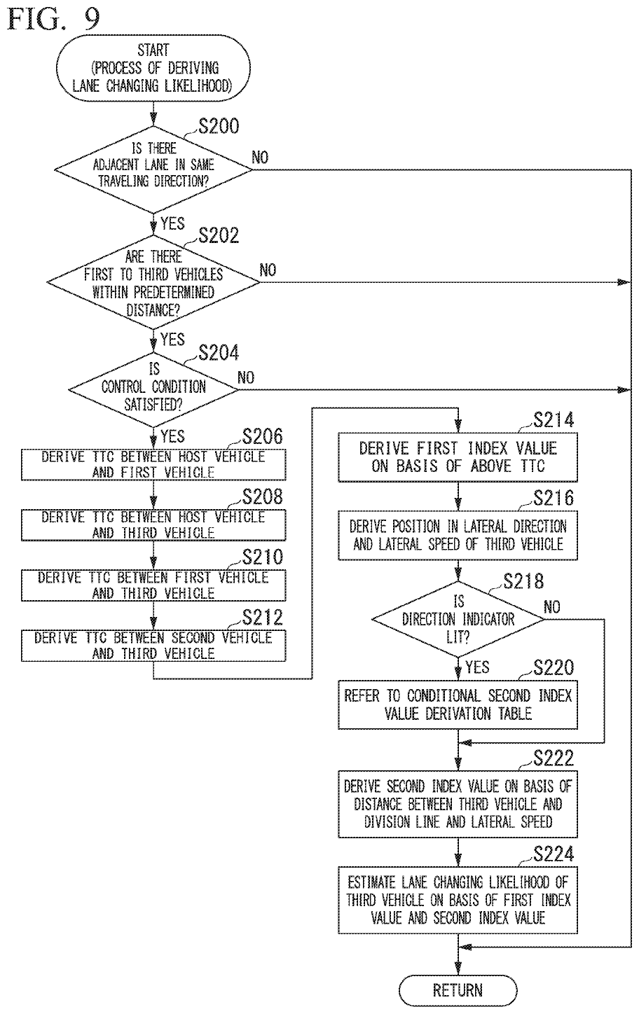

FIG. 9 is a flowchart showing a flow of a process that is executed by the first controller 120 of the modification example. Processes of steps S200 to S216 are the same as the processes of steps S100 to S116 of FIG. 5. Accordingly, descriptions thereof will be omitted here.

After the process of step S216, the first controller 120 determines whether or not the direction indicator of the third vehicle m3 is lighting to indicate an intention to perform lane changing into the first lane L1 on the basis of the recognition result of the peripheral recognizer 121 (step S218).

When the direction indicator of the third vehicle m3 is lighting to indicate the intention to perform lane changing into the first lane L1, the estimator 125 switches a map to be referred to from the second index value derivation map 154 to the conditional second index value derivation map 155 (step S220), and derives the second index value on the basis of the distance y between the third vehicle m and the division line DL and the lateral speed Vy of the third vehicle m3 by referring to the conditional second index value derivation map 155 (step S222).

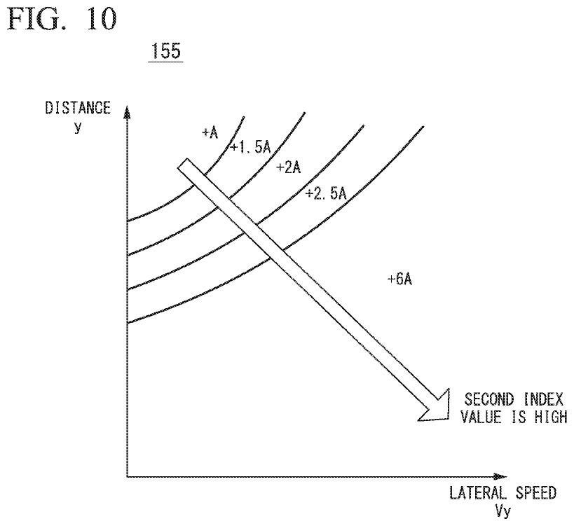

FIG. 10 is a diagram showing an example of the conditional second index value derivation map 155. In the conditional second index value derivation map 155, the distance y and the lateral speed Vy of the third vehicle m3 are stored in association with the second index value. The conditional second index value derivation map 155 is generated so that the second index value is derived to tend to be greater than that in the second index value derivation map 154 even when a relative relationship between the distance y and the lateral speed Vy of the third vehicle m3 is the same as that in the second index value derivation map 155. The conditional second index value derivation map 155 is generated on the basis of a correlation among the second index value, the distance y, and the lateral speed Vy of the third vehicle m3, which has been derived from a result of changing lanes of the third vehicle m when the direction indicator of the third vehicle m3 actually observed in advance has lit to indicate the intention to perform lane changing into the first lane L1, an experimental scheme, the simulation, and the like. When an intention to perform the lane changing into the third vehicle m3 is confirmed, the second index value is derived to be greater than that when the intention to perform lane changing into the third vehicle m3 is not confirmed, so that the likelihood of changing lanes can be derived more accurately.

When the direction indicator of the third vehicle m3 is not lighting to indicate the intention to perform lane changing into the first lane L1, the estimator 125 derives the second index value on the basis of the distance y between the third vehicle m and the division line DL and the lateral speed Vy of the third vehicle m3 by referring to the second index value derivation map 154 (step S222). Then, the estimator 125 estimates the likelihood of changing lanes into the first lane L1 in the third vehicle m3 on the basis of the first index value and the second index value by referring to the lane change estimation map 156 (step S224). Accordingly, the process of one routine of this flowchart ends.

A conditional lane change estimation map may be stored in the storage 150 in addition to the lane change estimation map 156. In this case, when the direction indicator of the third vehicle m3 indicates the intention to perform lane changing into the first lane L1, the estimator 125 may estimate the lane changing likelihood of the third vehicle m3 by referring to the conditional lane change estimation map. The conditional lane change estimation map is generated so that the lane changing likelihood is derived to tend to be higher than that of the lane change estimation map 156 even when the relative relationship between the first index value and the second index value is the same. It should be noted that the conditional second index value derivation map 155 may be used in addition to the conditional lane change estimation map, or when the conditional lane change estimation map is used, the second index value derivation map 154 may be used instead of the conditional second index value derivation map 155. When the conditional lane change estimation map may be used, the lane changing likelihood of the third vehicle m3 is estimated to be high. Thus, the lane changing likelihood of the third vehicle m3 is estimated more accurately.

### Modification Example 2

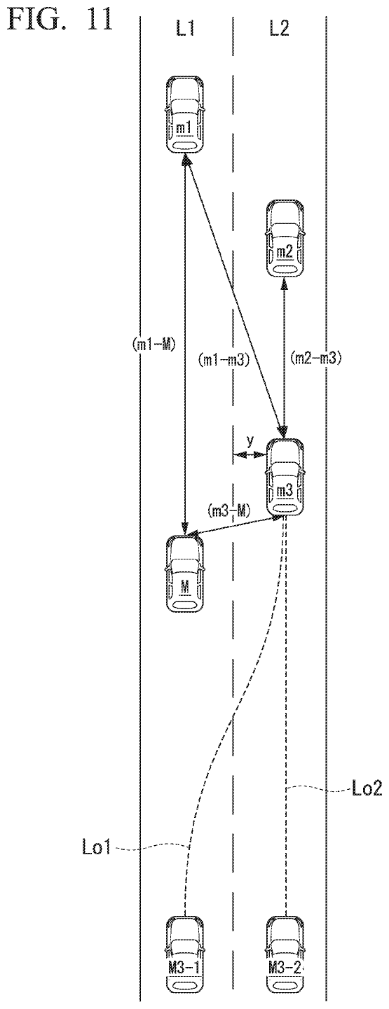

The estimator 126 may further estimate the likelihood of changing lanes from the second lane L2 to the first lane L1 in the third vehicle m3 by additionally considering a travel history of the third vehicle m3. FIG. 11 is a diagram showing an example of the travel history of the third vehicle m3. Description of the same content as that in FIG. 4 will be omitted. In the shown example, it is assumed that the third vehicle m3 has accelerated and traveled (overtook) to be present in the front of the host vehicle M from behind the host vehicle M. When the third vehicle m3 has accelerated and overtook the host vehicle M, the estimator 126 estimates that the lane changing likelihood of the third vehicle m3 is higher than that when the third vehicle m3 has overtook the host vehicle M without accelerating.

Further, in a case in which the third vehicle m3 has overtook the host vehicle M as indicated by a locus Lo1 when the third vehicle m3 has overtook the host vehicle M as described above, the estimator 126 estimates that the lane changing likelihood of the third vehicle m3 is higher than that in a case in which the third vehicle m3 has overtook the host vehicle M as indicated by a locus Lo2. The locus Lo1 is a locus when the third vehicle m3 has overtook the host vehicle M after the third vehicle m3 has performed lane changing into the second lane L2 from a state in which the third vehicle m3 is traveling behind the host vehicle M in the first lane L1. The locus Lo2 is a locus when the third vehicle m3 has overtook the host vehicle M in a state in which the third vehicle m3 is traveling behind the host vehicle M in the second lane L2.

As described above, the estimator 126 further estimates the likelihood of changing lanes from the second lane L2 to the first lane L1 in the third vehicle m3 by additionally considering the travel history of the third vehicle m3. Thus, it is possible to more accurately estimate the lane changing likelihood of the third vehicle m3.

### Modification Example 3

When there is a merged road (or when a lane adjacent to the lane in which the host vehicle M travels disappears), the virtual vehicle setter 123A sets a virtual second vehicle vm2 corresponding to the second vehicle m2. The first index value deriver 124 regards the virtual second vehicle vm2 as the second vehicle m2 and derives the first index value.

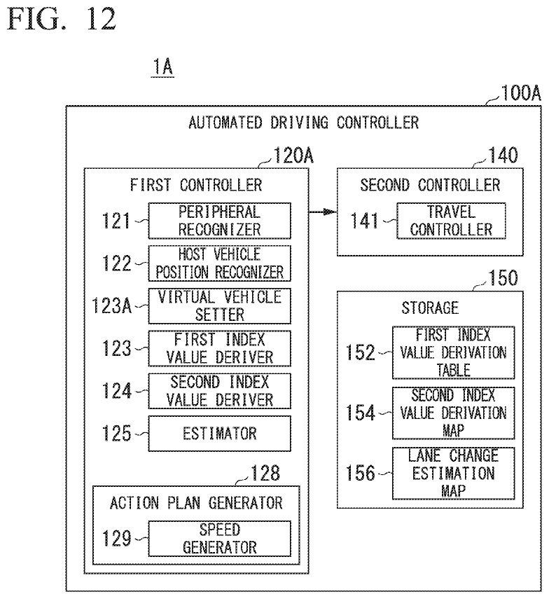

The vehicle system 1A of modification example 2 includes an automated driving controller 100A in place of the automated driving controller 100. FIG. 12 is a diagram showing a functional configuration of an automated driving controller 100A of modification example 2. The automated driving controller 100A includes, for example, a first controller 120A. The first controller 120A further includes the virtual vehicle setter 123A in addition to a functional configuration of the first controller 120.

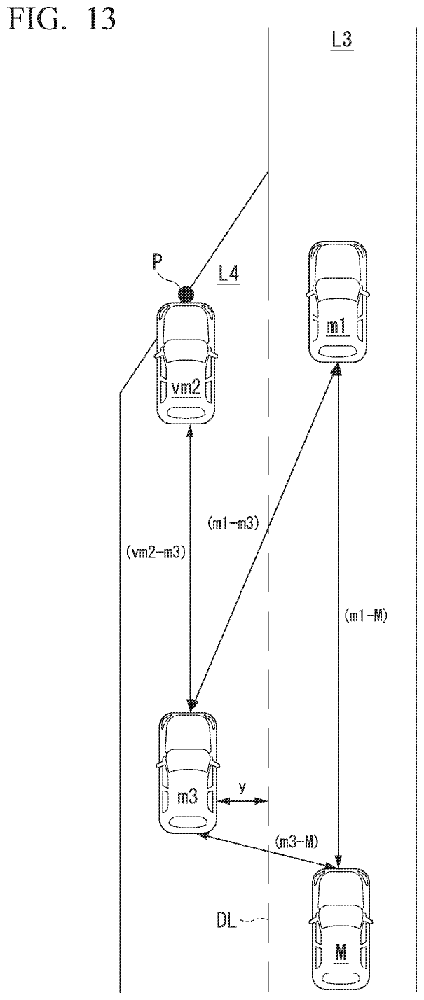

FIG. 13 is a diagram showing an example of a scene in which a merged road is present. The first controller 120 recognizes the host vehicle M, the first vehicle m1 present in front of the host vehicle M in a third lane L3 in which there is the host vehicle M, and the third vehicle m3 traveling on a merged road L4 (a fourth lane) connected to (adjacent to) the third lane L3 on the basis of the recognition results of the peripheral recognizer 121 and the host vehicle position recognizer 122.

The virtual vehicle setter 123A sets the virtual second vehicle vm2 on the basis of a point P at which the merged road L4 disappears. The first index value deriver 123 derives the first index value based on a relationship regarding the traveling direction between two vehicles among the host vehicle M, the first vehicle m1 present in front of the host vehicle M in the third lane L3 in which there is the host vehicle M, the second vehicle vm2 traveling in a merged road (a fourth lane) adjacent to the third lane L3 and present in front of the host vehicle, and the third vehicle m3 present in the fourth lane L4 and present behind the second virtual vehicle vm2, for a plurality of sets of two vehicles.

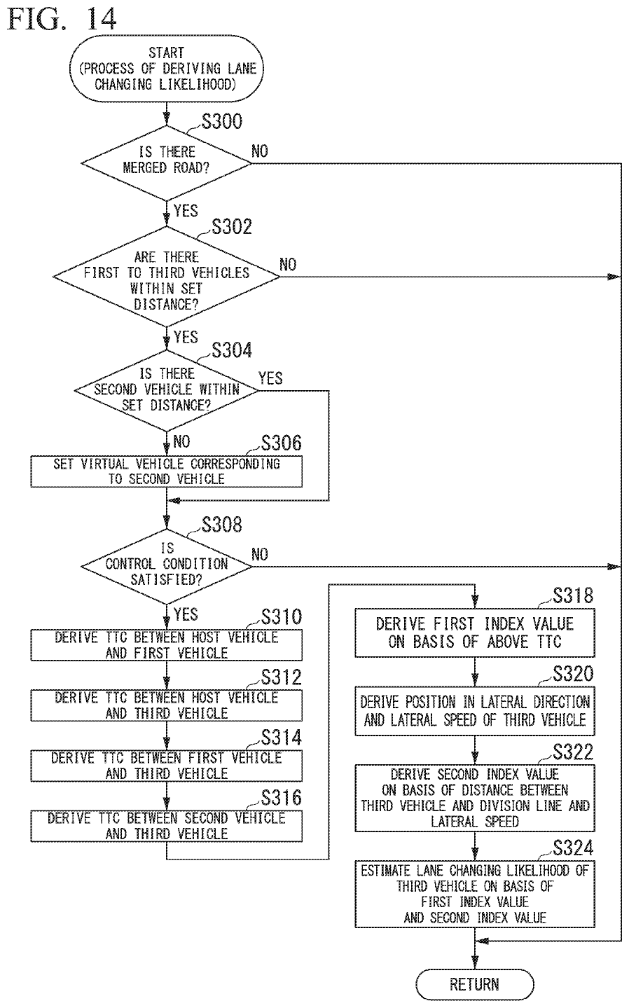

FIG. 14 is a flowchart showing a flow of a process that is executed by the first controller 120. This process is performed at predetermined periods. Hereinafter, each process will be described with reference to FIG. 13 described above.

First, the first controller 120 determines whether or not the merged road L4 is present within the predetermined distance in front of the host vehicle M on the basis of the current position of the host vehicle M and the information acquired from the second map information 62 (step S300). When the merged road L4 is not present, the process of one routine of this flowchart ends.

When the merged road L4 is present, the first controller 120 determines whether or not the first vehicle m1 and the third vehicle m3 are present within the predetermined distance from the host vehicle M on the basis of the recognition results of the peripheral recognizer 121 and the host vehicle position recognizer 122 (step S302). When the first vehicle m1 and the third vehicle m3 are not present within the predetermined distance from the host vehicle M, the process of one routine of this flowchart ends.

When the first vehicle m1 and the third vehicle m3 are present within a predetermined distance from the host vehicle M, the first controller 120 determines whether or not the second vehicle m2 is present within the set distance (step S304). When the second vehicle m2 is present within the set distance, processes of steps S308 to S324 are performed. The processes of steps S308 to S324 are the same as the processes (steps S104 to S120) of the flowchart of FIG. 5. It should be noted that when the second vehicle m2 is present within the set distance, the process of one routine of this flowchart may end. When the second vehicle m2 is present at a place at which the merged road L4 is present, it is also necessary to estimate the lane changing likelihood of the second vehicle m2, and this is intended to apply a process different from this process.

When there is no second vehicle m2 within the set distance, the virtual vehicle setter 123A sets the virtual second vehicle vm2 at the point P at which the merged road L4 disappears (step S306). Then, the estimator 125 determines whether or not a predetermined control condition is satisfied (step S308). When the predetermined control condition is not satisfied, the process of one routine of this flowchart ends.

When the predetermined control condition is satisfied, the first index value deriver 123 derives TTC(m1-M) between the host vehicle M and the first vehicle m1 (step S310). Then, the first index value deriver 123 derives TTC(M-m3) between the host vehicle M and the third vehicle m3 (step S312), derives TTC(m1-m3) between the first vehicle m1 and the third vehicle m3 (step S314), and derives TTC(vm2-m3) between the virtual second vehicle m2 and the third vehicle m3 (step S316).

Then, the estimator 125 derives the first index value on the basis of the TTC derived through the above process and the first index value derivation table 152 (step S318). The processes of steps S320 to S324 of this process are the same as the processes of steps 116 to 120 of FIG. 5. Accordingly, descriptions thereof will be omitted here.

Through the above-described process, the virtual vehicle setter 123A sets a virtual line on the basis of the point at which the lane disappears when the adjacent lane disappears. The estimator 126 estimates the lane changing likelihood of the third vehicle m3 using an index value indicating a relationship regarding a traveling direction between two vehicles among the host vehicle M, the first vehicle m1, the virtual second vehicle vm2, and the third vehicle m3 derived by the first index value deriver 123. Thus, it is possible to estimate the lane changing likelihood of the third vehicle m3 more accurately.

### [Speed Control]

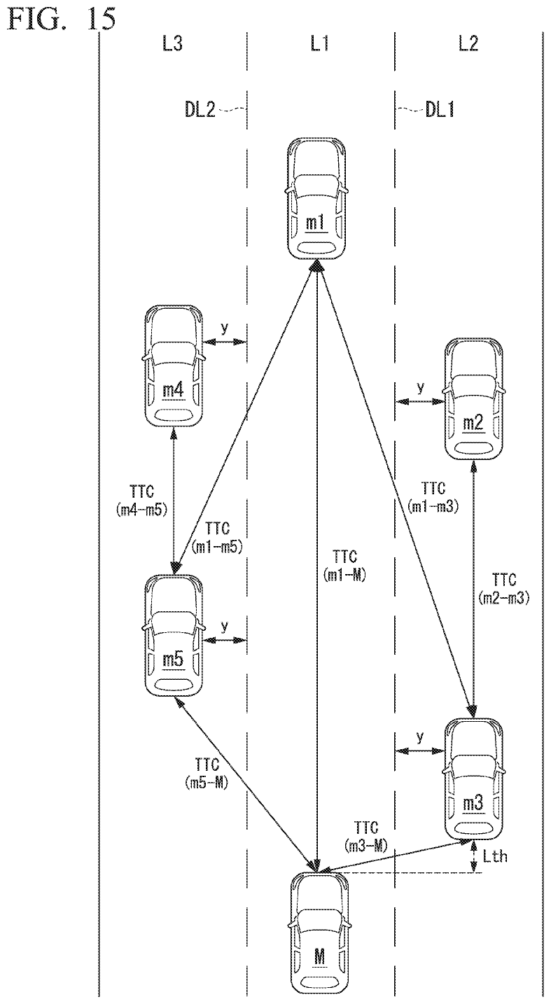

FIG. 15 is a diagram showing speed control. The peripheral recognizer 121 recognizes the first vehicle m1 traveling in front of the host vehicle M in the first lane L1 in which the host vehicle M travels, and the vehicle B traveling between the first vehicle m1 and the host vehicle M in the traveling direction in the second lane L2 adjacent to the first lane L1, on the basis of information input from the camera 10, the radar device 12, and the finder 14 via the object recognition device 16. The first vehicle m1 is an example of the “vehicle A”. The second vehicle m2 or the third vehicle m3 is an example of the “vehicle B”.

The peripheral recognizer 121 recognizes a vehicle C traveling between the first vehicle m1 and the host vehicle M in the traveling direction in the third lane L3 being adjacent to the first lane L1 and being on the side opposite to the second lane L2, on the basis of information input from the camera 10, the radar device 12, and the finder 14 via the object recognition device 16. The second vehicle m4 or the fifth vehicle m5 is an example of the “vehicle C”. Hereinafter, one or more vehicles B and one or more vehicles C may be generically called “target vehicles.”

The speed generator 129 controls the speed of the host vehicle M on the basis of the speed of the first vehicle m1 and the estimation result of the estimator 125 (for example, the likelihood of changing lanes into the first lane by one or more target vehicles among the second to fifth vehicles m2 to m5). Further, the speed generator 129 controls the speed of the host vehicle M on the basis of the speed of the first vehicle m1 and the lane changing likelihood of the target vehicle having a high likelihood of changing lanes into the first lane L1 in the estimation result of the estimator 125.

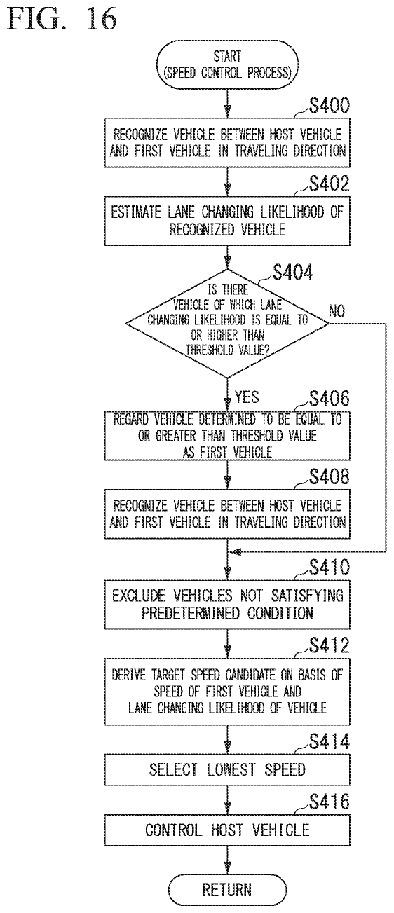

FIG. 16 is a flowchart showing a flow of a process of speed control that is executed by the first controller 120. First, the peripheral recognizer 121 recognizes a vehicle present between the host vehicle M and the first vehicle m1 in the traveling direction of the host vehicle M (step S400). The vehicles present between the vehicle M and the first vehicle m1 are the second to fifth vehicles m2 to m5 in the example of FIG. 15. When the first vehicle m is not present within a predetermined distance from the host vehicle M, a vehicle present within the predetermined distance from the host vehicle M is recognized as a target vehicle of this process. The predetermined distance is a distance that is set according to the speed of the host vehicle M, the target speed, and the like.

Further, the target vehicle of which a rear end is not in front of a front end of the host vehicle M in the traveling direction may be excluded even when the vehicle is present between the host vehicle M and the first vehicle m1. Further, the target vehicle of which a distance from a rear end of the target vehicle to the front end of the host vehicle M is not equal to or greater than the predetermined distance Lth shown in FIG. 15 may be excluded even when the vehicle is present between the host vehicle M and the first vehicle m1. By excluding the vehicle of which the distance is not equal to or greater than the predetermined distance Lth as described above, it is possible to suppress meaningless change in a behavior of the vehicle due to erroneous detection of sensors such as the radar device 12 and the finder 14. Further, it is possible to reduce a processing load.

Then, the estimator 125 estimates the lane changing likelihood of the second to fifth vehicles m2 to m5 recognized by the peripheral recognizer 121 (step S402). The estimator 125, for example, estimates a likelihood of changing lanes into the first lane L1 in the second to fifth vehicles m2 to m5 on the basis of a concept of the process described in the “Process of estimating a lane changing likelihood” above for the second to fifth vehicles m2 to m5.

It should be noted that although a scheme of estimating the lane changing likelihood for the processes of the second vehicle m2 and the third vehicle m5 has not been described in detail in the description of the “Process of estimating a lane changing likelihood” described above, the lane changing likelihood may be estimated by considering the following. For example, when the estimator 125 estimates the lane changing likelihood for the second vehicle m2, the estimator 125 regards the second vehicle m2 as the third vehicle m3, and when there is a vehicle in front of the second vehicle m2, the estimator 125 regards the vehicle as the second vehicle m2 and estimates the lane changing likelihood for the second vehicle m2 regarded as the third vehicle m3. Further, when there is no vehicle in front of the second vehicle m2, a process is performed similarly to a case in which there is no vehicle in front of the third vehicle m3. Further, for the fourth vehicle m4, even in a case in which the lane changing likelihood is estimated, the lane changing likelihood is estimated similarly to the second vehicle m2. Further, the second vehicle m2 or the third vehicle m3 may be excluded from processing targets. Further, for the process of estimating a lane changing likelihood described above, another known scheme may be used as an example.

Then, the first controller 120 determines whether or not there is a vehicle of which a lane changing likelihood is equal to or higher than a threshold value (for example, 0.9 or 1.0) in the estimation result of the estimator 125 (step S404). When there is no vehicle of which the lane changing likelihood is equal to or greater than the threshold value, the process proceeds to step S410.

When there is a vehicle of which the lane changing likelihood is equal to or greater than the threshold value, the first controller 120 regards the vehicle determined to be equal to or greater than the threshold value in step S404 as the first vehicle, instead of the vehicle regarded as the first vehicle m1 in step S400 (step S406). For example, when a vehicle present in the second lane L2 or the third lane L3 adjacent to the first lane L1 approaches the division line DL1 or DL2 or enters the first lane L1, the vehicle is regarded as a vehicle that has performed lane changing into the first lane L1 and becomes the first vehicle m1. The first controller 120 recognizes a vehicle present between the first vehicle m1 regarded as the first vehicle m1 in step S406 and the host vehicle M (step S408).

Then, the first controller 130 excludes vehicles not satisfying the predetermined condition from among the vehicles recognized in step S400 or S408 (step S410). The predetermined condition is, for example, a vehicle of which a relative speed with respect to the host vehicle M is positive or zero. Further, the predetermined condition may be, for example, that the likelihood of changing lanes into the first lane L1 in the estimation result of the estimator 125 exceeds a threshold value.

Then, the speed generator 129 derives target speed candidates of the host vehicle M on the basis of the speed of the first vehicle m1 and the lane changing likelihood of the vehicle not excluded in step S410 (step S412). For example, the speed generator 129 derives the target speed candidates on the basis of the speed of the second to fifth vehicles m2 to m5 and the lane changing likelihood, using Equation (1) below. In Equation (1), “Vego_mn” denotes a target speed candidate of the host vehicle M with reference to the target vehicle n, and “n” denotes the target vehicle (one of the second to fifth vehicles m5). “Pmn” denotes a likelihood of changing lanes into the first lane by a target vehicle present in an adjacent lane (for example, a probability value indicated by 0.0 to 1.0), “Vm1” denotes a speed of the first vehicle m1, and “Vmn” denotes a speed of the target vehicle.

Vego_mn=(1−Pmn)Vm1+Pmn Vmn (1)

Then, the speed generator 129 selects the smallest target speed candidate among the plurality of target speed candidates derived in step S410 as a target speed (step S414). The speed generator 129 controls the host vehicle M on the basis of the target speed selected in step S414 (step S416). Accordingly, the process of one routine of this flowchart ends.

As the likelihood of the target vehicle performing lane changing increases, a value of a first term of Equation (1) tends to approach zero and a value of a second term tends to approach the speed of the target vehicle. For example, when the first vehicle m1 to the fifth vehicle m5 are traveling at the same speed, and when the lane changing likelihood of the third vehicle m3 is highest, the target speed candidate with reference to the third vehicle m3 in Equation (1) is smallest. The speed generator 129 determines the target speed on the basis of Equation (1) and controls the speed of the host vehicle M on the basis of the determined target speed so that the speed of the host vehicle M is controlled to smoothly follow the vehicle that has performed lane changing even when the vehicle having a high likelihood of performing lane changing has performed lane changing into the first lane L1. Thus, the first controller 120 can perform speed control with less discomfort according to a lane changing behavior of the nearby vehicle.

According to the above-described embodiment, it is possible to perform speed control with less discomfort according to a lane changing behavior of the nearby vehicle by including the peripheral recognizer 121 that recognizes the first vehicle m1 traveling in the front of the host vehicle M in the first lane L1 in which the host vehicle M travels, and the vehicle B traveling between the first vehicle m1 and the host vehicle M in the traveling direction in the second lane L2 adjacent to the first lane L1, which are detected by the camera 10, the radar device 12, and the finder 14 that detect the situation of a periphery of the host vehicle M, the estimator 125 that estimates the likelihood of changing lanes into the first lane L1 by the vehicle B recognized by the peripheral recognizer 121, and the first controller 120 (the speed generator 129) that controls the speed of the host vehicle M on the basis of the speed of the first vehicle m1 and an estimation result of the estimator 125.

According to the above-described embodiment, it is possible to derive the lane changing likelihood of the nearby vehicle more accurately by including the first index value deriver 123 that derives the first index value based on the relationship regarding the traveling direction between two vehicles among the host vehicle M, the first vehicle m1 traveling in front of the host vehicle M in the first lane L1 in which the host vehicle M travels, the second vehicle m2 (the virtual second vehicle vm2)) traveling in the second lane L2 adjacent to the first lane L1 and traveling in front of the host vehicle M, and the third vehicles m3 traveling in the second lane L2 and traveling behind the second vehicle m2, for the plurality of sets of two vehicles, on the basis of the situation of a periphery of the host vehicle M detected by the camera 10, the radar device 12, or the finder 14 that detects the situation of a periphery of the host vehicle, and the estimator 125 that estimates the lane changing likelihood of the third vehicle m3 on the basis of the first index value derived by the first index value deriver 123 and the position of the third vehicle m3 in the lateral direction.

Although the form for carrying out the present invention has been described above using the embodiment, the present invention is not limited by such an embodiment at all, and various modifications and substitutions can be added without departing from the gist of the present invention.

### REFERENCE SIGNS LIST

1 Vehicle system
10 Camera
16 Object recognition device
20 Communication device
100 Automated driving controller
120 First controller
121 Peripheral recognizer
122 Host vehicle position recognizer
123A Virtual vehicle setter
123 First index value deriver
124 Second index value deriver
125 Estimator
128 Action plan generator
129 Speed generator
140 Second controller
141 Travel controller

1. A vehicle control apparatus comprising:
a recognizer configured to recognize a vehicle A traveling in front of a host vehicle in a first lane in which the host vehicle travels, and a vehicle B traveling between the vehicle A and the host vehicle in a traveling direction in a second lane adjacent to the first lane, the vehicle A and the vehicle B being detected by a detector that detects a situation of a periphery of the host vehicle;
an estimator configured to estimate a likelihood of changing lanes into the first lane by the vehicle B recognized by the recognizer; and
a vehicle controller configured to control a speed of the host vehicle on the basis of a speed of the vehicle A and an estimation result of the estimator.

2. The vehicle control apparatus according to claim 1,
wherein the recognizer is configured to recognize a vehicle C traveling between the vehicle A and the host vehicle in a traveling direction in a third lane adjacent to the first lane and on a side opposite to the second lane, the vehicle C being detected by the detector that detects the situation of a periphery of the host vehicle,
the estimator is configured to estimate a likelihood of changing lanes into the first lane by the vehicle C recognized by the recognizer, and
the vehicle controller is configured to control a speed of the host vehicle on the basis of the speed of the vehicle A and a lane changing likelihood of a target vehicle having a high likelihood of changing lanes into the first lane in the estimation result of the estimator.

3. The vehicle control apparatus according to claim 2,
wherein the recognizer is configured to recognize a plurality of target vehicles including the vehicle B and the vehicle C, the target vehicles traveling between the vehicle A and the host vehicle in the traveling direction and traveling in the second lane or the third lane,
the estimator is configured to estimate the likelihood of changing lanes into the first lane by each of the plurality of target vehicles recognized by the recognizer, and
the vehicle controller is configured to control the speed of the host vehicle on the basis of the speed of the vehicle A and a lane changing likelihood of a target vehicle having a high likelihood of changing lanes into the first lane among the plurality of target vehicles in the estimation result of the estimator.

4. The vehicle control apparatus according to claim 3, wherein the vehicle controller is configured to further control the speed of the host vehicle on the basis of a speed of a target vehicle having a high likelihood of changing lanes into the first lane among the plurality of target vehicles.

5. The vehicle control apparatus according to claim 3, wherein the estimator is configured to control the speed of the host vehicle using a set speed instead of the speed of the vehicle A when the recognizer does not recognize the vehicle A within a set distance.

6. The vehicle control apparatus according to claim 3, wherein the vehicle controller is configured to exclude, as the vehicle B or the vehicle C, a vehicle of which a rear end is not in front of a front end of the host vehicle in the traveling direction, or a vehicle of which a distance from a rear end thereof to the front end of the host vehicle is not equal to or greater than a predetermined distance.

7. The vehicle control apparatus according to claim 3, wherein the vehicle controller is configured to exclude, as the vehicle B or the vehicle C, a vehicle of which a relative speed with respect to the host vehicle is negative.

8. The vehicle control apparatus according to claim 3, wherein the vehicle controller is configured to exclude, as the vehicle B or the vehicle C, a vehicle of which a likelihood of changing lanes into the first lane in the estimation result of the estimator is equal to or smaller than a threshold value.

9. The vehicle control apparatus according to claim 3, wherein the vehicle controller is configured to regard the vehicle B or the vehicle C of which the estimation result of the estimator is equal to or greater than a threshold value as the vehicle A in a process of repeatedly controlling the speed of the host vehicle.

10. A vehicle control apparatus comprising:
a recognizer configured to recognize a vehicle A traveling in front of a vehicle in a first lane in which the host vehicle travels, and a plurality of target vehicles traveling between the vehicle A and the host vehicle in the traveling direction and traveling in a lane adjacent to the first lane;
an estimator configured to estimate a likelihood of changing lanes from the lane adjacent to the first lane to the first lane for each of the plurality of target vehicles recognized by the recognizer; and
a vehicle controller configured to control a speed of the host vehicle on the basis of a speed of the vehicle A and a lane changing likelihood of a target vehicle having a high likelihood of changing lanes into the first lane among the plurality of target vehicles in an estimation result of the estimator.

11. A vehicle control method comprising:
recognizing, by a vehicle-mounted computer, a vehicle A traveling in front of a host vehicle in a first lane in which the host vehicle travels, and a vehicle B traveling between the vehicle A and the host vehicle in a traveling direction in a second lane adjacent to the first lane, the vehicle A and the vehicle B being detected by a detector that detects a situation of a periphery of the host vehicle;
estimating, by the vehicle-mounted computer, a likelihood of changing lanes into the first lane by the recognized vehicle B; and
controlling, by the vehicle-mounted computer, a speed of the host vehicle on the basis of a speed of the vehicle A and a result of the estimation.

12. (canceled)
